(19) United States
(12) Patent Application Publication
(10) Pub. No.: US 2014/0305678 A1
(43) Pub. Date: Oct. 16, 2014

(54) WIRING MATERIAL

(71) Applicant: Sumitomo Wiring Systems, Ltd., Yokkaichi-City (JP)

(72) Inventor: Takao Fukuda, Yokkaichi-City (JP)

(73) Assignee: Sumitomo Wiring Systems, Ltd., Yokkaichi-City (JP)

(21) Appl. No.: 14/249,834

(22) Filed: Apr. 10, 2014

(30) Foreign Application Priority Data
Apr. 11, 2013 (JP) 2013-082978

(51) Int. Cl. H01B 7/282; H01R 43/00

(52) U.S. Cl. CPC H01B 7/2825; H01R 43/005
USPC 174/110 R; 29/825

(57) ABSTRACT

A wiring material (10) includes a wire (20) with a core (22) formed by bundling a plurality of strands (21) and a coating (26) covering the core (22), and a sealing member (30) for covering an exposed core (24) of the wire (20) and the coating (26) at opposite end sides of the exposed core portion (24). The coating (26) is partly removed at a longitudinal intermediate part thereof to form the exposed core (24), and the exposed core (24) is formed with resistance welding portions, in which the plurality of strands are resistance-welded to each other, at a plurality of positions spaced apart in a longitudinal direction of the exposed core (24).

### BACKGROUND

1. Field of the Invention

The invention relates to a technique for waterproofing a longitudinal intermediate part of a wiring material.

2. Description of the Related Art

Japanese Unexamined Patent Publication No. 2004-72943 discloses a waterproof structure for wire where an intermediate part of an insulation coating of a wire is removed to expose a core, and a multitude of strands of the core in this exposed part are welded to each other. A tape applied with silicone then is wound around the exposed core including the welded part or a heat shrinkage tube is mounted on it and shrunk.

Welding the strands in Japanese Unexamined Patent Publication No. 2004-72943 eliminates clearances between the strands. However, there is a possibility that clearances continuous along a longitudinal direction of the strands remain between the strands. Water can enter through such clearances and hence sufficient waterproof performance may be not obtained.

The invention aims to improve waterproof performance of a wiring material.

### SUMMARY OF THE INVENTION

The invention relates to a wiring material that includes a wire with a core formed by bundling a plurality of strands and a coating covering the core. The coating is partly removed at a longitudinal intermediate part of the wire to form an exposed core portion. The exposed core portion is formed with resistance welding portions, in which the strands are resistance-welded at a plurality of positions spaced apart in a longitudinal direction thereof. A sealing member covers the exposed core of the wire and the coating portion at opposite end sides of the exposed core. The plural spaced apart resistance welding portions suppress entrance of water through clearances between the strands more reliably and waterproof performance of the wiring material can be improved.

The resistance welding portions preferably comprise three or more resistance welding portions. Thus, waterproofing can be performed more reliably.

The sealing member preferably is formed by applying heating in a state where the exposed core of the wire and the coating at the opposite ends of the exposed core are covered by a heat shrinkable tube with a hot-melt agent inside. The exposed core can be sealed quickly and easily by heating the heat shrinkable tube with the hot-melt agent inside.

Alternatively, the sealing member may be formed by winding a sheet-like material around the exposed core of the wire and the coating at the opposite ends of the exposed core. The exposed core in the longitudinal intermediate part of the wire can be easily sealed by the sheet-like member.

### BRIEF DESCRIPTION OF THE DRAWINGS

FIG. 1 is a schematic plane view showing a wiring material according to an embodiment,

FIG. 2 is a diagram showing a manufacturing process of the wiring material,

FIG. 3 is a diagram showing the manufacturing process of the wiring material,

FIG. 4 is a diagram showing the manufacturing process of the wiring material,

FIG. 5 is a diagram showing the manufacturing process of the wiring material,

FIG. 6 is a schematic section of a resistance welding portion,

FIG. 7 is a schematic section of a resistance welding portion,

FIG. 8 is a diagram showing a manufacturing process of a wiring material according to a modification, and

FIG. 9 is a schematic plan view showing the wiring material according to the modification.

### DETAILED DESCRIPTION OF THE PREFERRED EMBODIMENTS

FIG. 1 is a schematic plan view showing a wiring material 10. This wiring material 10 is used as a wire in a vehicle such as a ground wire for grounding an electric device to a body of a vehicle. Of course, this wiring material 10 may be used as another wire such as a power wire or a signal wire.

The wiring material 10 includes a wire 20 and a sealing member 30.

The wire 20 includes a core 22 formed by bundling a plurality of strands 21, and a coating 26 covering the core 22. The coating 26 is formed, for example, such as by coating the core 11 with extruded molten resin.

The coating 26 is removed on an end part of the wire 20 to form an exposed core 23 for connection on the end part of the wire 20. A terminal 28 is crimped and connected to this exposed core 23. The wire 20 is connected electrically and mechanically to a body or the like, which is a metal part of a vehicle body, via the terminal 28. Note that the other end of the wire 20 is connected electrically to a ground circuit of the electric device directly or by a terminal, a connector or the like.

A part of the coating 26 is removed at a longitudinal intermediate part of the wire 20 to form an exposed core 24. The exposed core 24 is formed with resistance welding portions 25 at a plurality of positions spaced apart in a longitudinal direction thereof. The resistance welding portions 25 are formed at positions inward of opposite end parts of the exposed core 24. Here, three resistance welding portions 25 are provided, and non-resistance welding portions 24a provided between the respective resistance welding portions 25. Note that it is sufficient to provide a plurality of resistance welding portions. Thus, a configuration with only two resistance welding portions or a configuration with four or more resistance welding portions may also be adopted. Three or more resistance welding portions 25 are preferred for more reliable waterproofing.

Each resistance welding portion 25 is a part in which a plurality of strands 21 are joined to each other by resistance welding and clearances between the respective strands 21 are eliminated.

The strands 21 in the non-resistance welding portion 24a are loosely present without being joined to each other. Thus, the respective strands 21 in the non-resistance welding portion 24a are in a relatively disordered state, as compared with in the resistance welding portion 25.

The sealing member 30 is formed to cover the exposed core 24 and parts of the coating 26 at opposite end sides of the exposed core 24. The sealing member 30 is formed by heating a heat shrinkable tube 31 and a hot-melt agent 32 in a state where the heat shrinkable tube 31 with the hot-melt agent 32 inside is mounted on the exposed core 24 and the parts of the coating 26 at the opposite sides of the exposed core 24 (see FIG. 5).

A manufacturing method of the wiring material 10 is described, centering on a waterproof part.

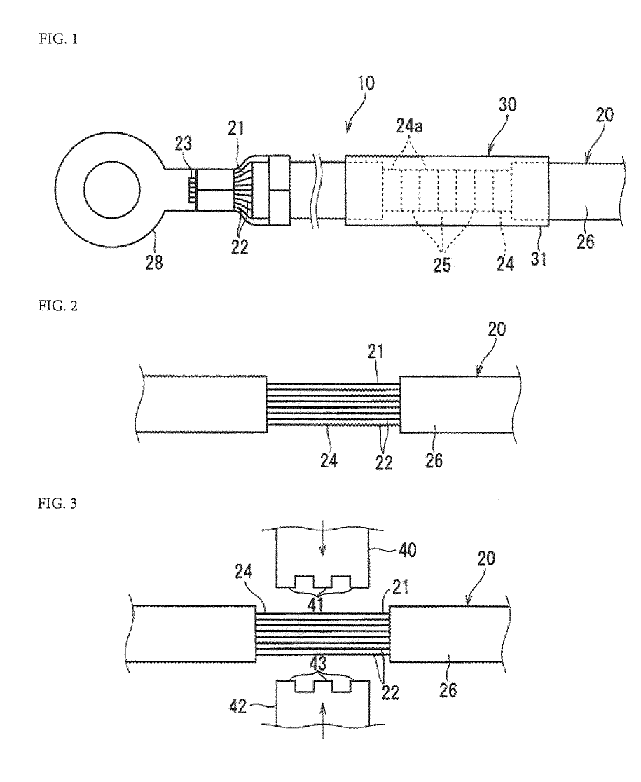

First, as shown in FIG. 2, the coating 26 is removed at a longitudinal intermediate part of the wire 20 to form the exposed core 24. In this stage, the strands 21 are in a loose state without being joined in the entire exposed core 24 in the longitudinal direction.

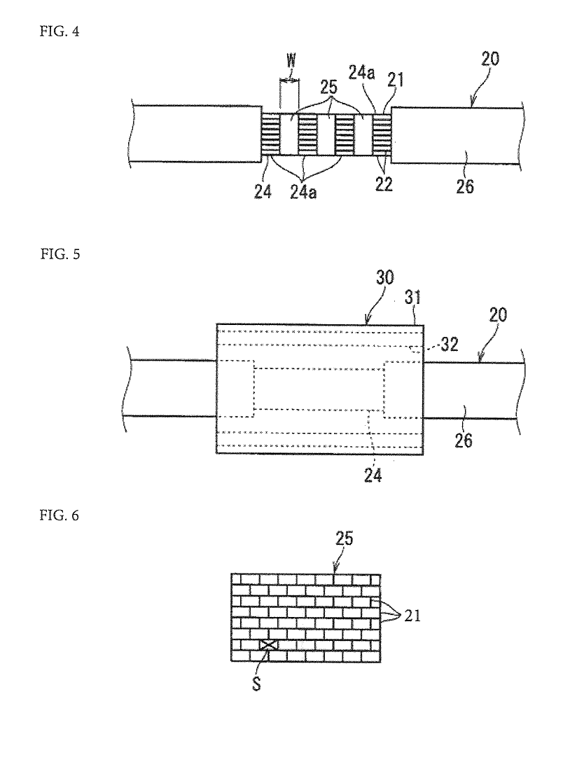

Subsequently, as shown in FIG. 3, resistance welding is applied to the exposed core 24 at a plurality of positions spaced apart in the longitudinal direction of the exposed core 24 by sandwiching the exposed core 24 between applicators for resistance welding 40 and 42. The applicators 40, 42 preferably are formed, for example, with contact portions 41, 43 at a plurality of positions spaced apart in the longitudinal direction of the exposed core 24, thereby forming recesses between the contact portions 41 and between the contact portions 43. This enables the resistance welding portions 25 to be formed on the exposed core 24 at a plurality of positions spaced apart in the longitudinal direction of the exposed core 24 as shown in FIG. 4.

Note that although a state where the resistance welding portions 25 are formed by pressing the exposed core 24 from upper and lower sides is shown in FIG. 3, it is actually preferable to press the exposed core 24 from four sides around the exposed core 24.

A welding width of each resistance welding portion 25 in the longitudinal direction of the exposed core 24 is preferably set at 2 mm or longer to ensure a certain degree of waterproofness by joining the strands 21 by resistance welding.

The resistance welding portions 25 preferably are resistance welded at a compression ratio of 100% or lower. Specifically, a cross-sectional area of a space surrounded by a pressed surface in resistance welding preferably is smaller than the sum total of cross-sectional areas of the strands 21 of the core 22 before resistance welding. This causes the strands 21 to be squeezed sufficiently in the resistance welding portion 25 so that the strands 21 tightly adhere to each other with no clearance. In this way, sufficient waterproofing between the strands 21 is achieved in the resistance welding portion 25.

Subsequently, as shown in FIG. 5, the exposed core 24 and the coating 26 at the opposite sides of the exposed core 24 are covered by the heat shrinkable tube 31 provided with the hot-melt agent 32 inside. When the heat shrinkable tube 31 and the hot-melt agent 32 are heated such as by hot air in this state, the heat shrinkable tube 31 is thermally shrunk and the hot-melt agent 32 is melted. Then, the heat shrinkable tube 31 covers the exposed core 24 and the coating 26 at the opposite sides of the exposed core 24 while being fastened to these parts, and the hot-melt agent 32 is filled between the exposed core 24 and the heat shrinkable tube 31. In this way, the exposed core portion 24 is sealed from the outside, thereby completing the wiring material 10 with the built-in waterproof structure shown in FIG. 1. Note that the terminal 28 is appropriately crimped before or after the above-described operation.

The exposed core 24 of the above-described wiring material 10 is formed with the resistance welding portions 25 where the strands 21 are resistance-welded to each other at the plurality of positions spaced apart in the longitudinal direction of the exposed core 24. Thus, the entrance of water through clearances between the strands 21 can be suppressed more reliably and waterproof performance of the wiring material 10 can be improved.

The strands 21 in the resistance-welded exposed core 24 ideally are joined to each other to eliminate clearances between the respective strands. Of course, an ideal resistance-welded state may not necessarily be achieved depending on an arrangement state of the plurality of strands 21. Therefore a clearance S may be formed between the strands 21 as show in FIG. 6.

However, since the resistance welding portions 25 are formed at the plurality of spaced-apart positions in this exposed core portion 24, a state of each resistance welding target part (e.g. the arrangement state of the strands 21) is thought to differ in performing resistance welding. Thus, even if clearances S are formed in some of the plurality of resistance welding portions 25, it can be expected that resistance welding is performed in an ideal state free from clearances in the other resistance welding portions 25. Thus, waterproofness of the strands 21 in the exposed core portion 24 can be improved.

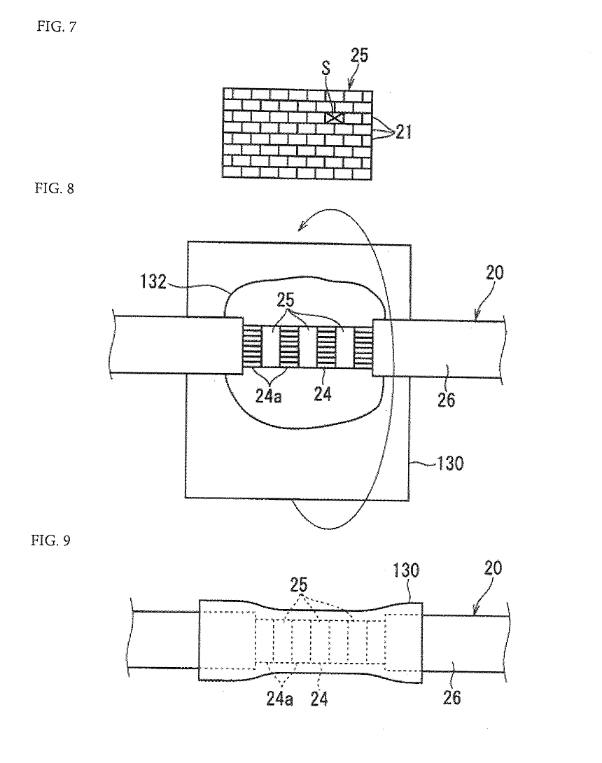

Further, as shown in FIG. 7, even if a clearance S is formed in the other resistance welding portion 25, it can be expected that the formation positions of the clearances S differ in the resistance welding portions 25 due to a difference in the state of the resistance welding target part. For example, although the clearance S is formed at a left-lower position of the resistance welding portion 25 in FIG. 6, the clearance S is formed at a right upper position of the resistance welding portion 25 in FIG. 7. If the clearances S are discontinuous and formed at different positions in the plurality of resistance welding portions 25 in this way, water hardly enters through the clearances S. Also in this respect, waterproofness of the strands 21 in the exposed core portion 24 can be improved.

From the above perspective, three or more resistance welding portions 25 are preferable. Despite dependence on the number of strands 21 and the like, if three or more resistance welding portions 25 are provided, a possibility of forming clearances S at the same position in the respective resistance welding portions 25 can be reduced to 1 ppm or lower.

Further, since the heat shrinkable tube 31 provided with the hot-melt agent 32 inside is used as the sealing member 30, the exposed core 24 can be covered by the sealing member 30 by inserting the wire 20 into the heat shrinkable tube 31 and applying heating, and the exposed core portion 24 can be quickly and easily sealed.

Further, the sealing member 30 needs not necessarily adopt a configuration using the heat shrinkable tube 31 as described above, and a sheet-like member may be wound around an exposed core portion and a coating portion at end sides of the exposed core portion to seal the exposed core portion.

In an example shown in FIGS. 8 and 9, silicone 132 is discharged onto a film-like sheet 130, and this sheet 130 is wound around the exposed core portion 24 and the coating portion 26 at the end sides of the exposed core portion 24.

The sheet 130 is rectangular and has a width exceeding the length of the exposed core 24 and a length sufficient to cover the coating 26 one turn or more.

By winding the sheet 130 around the exposed core 24 and the coating portion 26 at the end sides of the exposed core 24, these are sealed by the sheet 130 and the silicone 132 is present between the exposed core 24 and the sheet 130. By using this sheet-like 130, the longitudinal intermediate part of the wire 20 can be easily waterproofed.

Note that the silicone 132 preferably penetrates into between the strands 21 to waterproof the strands 21 also in the non-resistance welding portions 24a.

Note that ultraviolet curing resin, thermosetting resin, moisture curing resin and the like may be used instead of the silicone 132. Further, butyl sheet and the like may be used as the sheet-like material for sealing the exposed core portion.

Although this invention has been described in detail above, the above description is illustrative in all aspects and this invention is not limited thereto. It should be appreciated that unillustrated numerous modifications are possible without departing from the scope of this embodiment.

What is claimed is:

1. A wiring material, comprising:
a wire (20) including a core (22) formed by bundling strands (21) and a coating (26) covering the core (22), the coating (26) being partly removed at a longitudinal intermediate part thereof to form an exposed core (24), and the exposed core (24) being formed with resistance welding portions (25), in which the plurality of strands (21) are resistance-welded, at a plurality of positions spaced apart in a longitudinal direction of the exposed core (24); and
a sealing member (30) for covering the exposed core (24) of the wire (20) and the coating (26) at opposite end sides of the exposed core (24).

2. The wiring material of claim 1, wherein three or more resistance welding portions (25) are formed.

3. The wiring material of claim 1, wherein the sealing member (30) is formed by applying heating in a state where the exposed core (24) of the wire (20) and the coating (26) at the opposite end sides of the exposed core (24) are covered by a heat shrinkable tube (31) provided with a hot-melt agent inside (32).

4. The wiring material of claim 1, wherein the sealing member (30) is formed by winding a sheet-like material around the exposed core (24) of the wire (20) and the coating (26) at the opposite ends of the exposed core (24).
